(19) United States
(12) Patent Application Publication
(10) Pub. No.: US 2009/0252980 A1
(43) Pub. Date: Oct. 8, 2009

(54) GREASE-RESISTANT FILMS AND COATINGS

(75) Inventors: Michael C. Berg, Baltimore, MD (US); Patrick Duggan Kincaid, Hanover, MA (US); Gangadhar Jogikalmath, Cambridge, MA (US); David S. Soane, Chestnut Hill, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: NanoPaper, LLC, Cambridge, MA (US)

(21) Appl. No.: 12/401,841

(22) Filed: Mar. 11, 2009

Related U.S. Application Data
(60) Provisional application No. 61/035,857, filed on Mar. 12, 2008.

(51) Int. Cl. B32B 27/10; B05D 1/02; B05D 1/18

(52) U.S. Cl. 428/511; 427/427.6; 427/439

(57) ABSTRACT

Compositions and methods for rendering a substrate more grease-resistant are disclosed. Treatments, such as aqueous-based treatments and/or emulsions, can be applied to the surface of a substrate, such as paper-based materials, which can be dried to form a treatment layer imparting grease resistant properties. In some instances, the treatment includes an acrylic-based polymer, which can impart grease-resistance, and one or more complementary components (e.g., a polymer and/or oligomer) that can make a layer less brittle (e.g., lowering the T_{g} of the layer relative to a layer of acrylic-based polymer). Such treatment layers can retain their grease resistance even when creased, allowing the use of such layers in applications such as food processing. Other additives, compositions, and methods are further developed.

### CROSS REFERENCE TO RELATED APPLICATIONS

The present application claims the benefit of a U.S. Provisional Application bearing Ser. No. 61/035,857, filed Mar. 12, 2008, entitled “Grease Resistant Films and Coatings.” The present application is also related to a pending U.S. patent application bearing Ser. No. 11/857,630, filed Sep. 20, 2006, entitled “Grease Resistant Films.” Both of these applications are hereby incorporated herein by reference in their entirety.

### FIELD OF THE APPLICATION

This application relates generally to grease-resistant films, coatings, and compositions.

### BACKGROUND

Grease-resistant and/or oil-resistant coatings are used in a variety of applications including paper and board used in food packaging. Many of these treatments or coatings use fluorinated materials, and others use high amounts of polyolefins or other plastics. Concerns by consumers and regulatory agencies are driving the search for alternative coating materials. In addition to concerns regarding the safety of fluorinated materials, polyolefins or other plastics often make the paper non-recyclable. In some instances, grease resistant compositions can result in a product that is too brittle to allow folding or creasing of the treated paper. For these reasons and others, alternative coating materials are needed that withstand the penetration of oil or grease, while being acceptable to a wider base of consumers. It is further desirable that this material be aqueous based for use in conjunction with certain papermaking processes.

### SUMMARY

In embodiments, the systems disclosed herein provide for a grease-resistant paper product comprising a treated surface of a paper-based material, the treated surface including a dried treatment layer comprising an acrylic-based polymer and a complementary component, the complementary component being dispersible with the acrylic-based polymer, the treatment layer being more grease resistant that the paper-based material and less brittle than an equally-dimensioned layer of the acrylic-based polymer. In embodiments, the grease-resistant paper product can include a weight ratio greater than 3 to 100 of complementary component to acrylic-based polymer in the treatment layer. The treatment layer can be a mixed composition. The treatment layer can exhibit a T_{g} lower than the T_{g} of the acrylic-based polymer. The treatment layer can be substantially free of inorganic filler, or the treatment layer may comprise an inorganic filler. In embodiments, the grease-resistant paper product is capable of being creased, with the creased paper product still being more grease-resistant than the paper-based material. The treatment layer can comprise an acrylic-based polymer that is crosslinked with a crosslinking agent. In embodiments, the complementary component is a polymer. In embodiments, the complementary component is incapable of substantial leaching out of the treatment layer. In embodiments, the complementary component includes at least one of a polyol and a polyoxazoline. The polyol can be a polyglycol such as polyethylene glycol or polypropylene glycol. In embodiments, the complementary polymer is at least partially bound to the acrylic-based polymer. In embodiments, the grease-resistant paper product is configured as a food packaging material.

Disclosed herein are also, in embodiments, methods for producing a grease resistant product, comprising providing a treatment composition comprising at least one of an acrylic-based polymer and a reactive precursor to the acrylic-based polymer, and at least one of a complementary component and a reactive precursor to the complementary component, the acrylic-based polymer and complementary component being dispersible with one another; and forming a treatment layer from the treatment composition disposed on a surface of the paper product, the formed treatment layer being more grease-resistant than the paper product, and being less brittle than an equally dimensioned layer of the acrylic-based polymer. The step of forming can comprise treating the surface of the paper with the treatment composition by at least one of solvent-casting, spraying, dip coating, and extrusion. The step of forming can comprise forming a free-standing film layer with the treatment composition; and applying the free-standing film layer to the surface of the paper product. The step of forming can further comprise forming at least a portion of the paper product simultaneously using the treatment composition. In embodiments, the treatment composition is a water-based composition. In embodiments, the treatment composition is an emulsion. In embodiments, the complementary component is a polymer. The complementary component can include at least one of a polyol and a polyoxazoline. In embodiments, the reactive precursor to the complementary component is a reactive oligomer. In embodiments, the method can include reacting at least one of the acrylic-based polymer and the reactive precursor with at least one of a complementary component and a reactive precursor to the complementary component to cause binding. In embodiments, the treatment composition can be formulated to hinder leaching of the complementary component from the formed treatment layer.

### DETAILED DESCRIPTION

Disclosed herein are methods and compositions for formulating grease-resistant materials. Such materials can be formed on a substrate (e.g., a paper-based material), for example by using a treatment composition, to impart improved grease-resistant properties to the substrate. As described herein, “treatment compositions” are directed to protect a variety of substrates including paper-based materials, woods, plastics, and the like. Such treatment compositions, which can be formulated as a deformable mixture or a solid/fluid dispersion for example, can be used to produce films, coatings, and other dried treatment layers described and/or prepared according to embodiments herein. These treatment layers can be used as barriers to prevent the transmission of oil or grease to a substrate, for example when making material for food packaging and processing. When a grease-resistant material is used to treat a substrate (e.g., a paper product) in certain embodiments, it can also be referred to as a “treatment composition.”

Treatment layers can include free-standing films (i.e., layers which do not require a support substrate upon formation to maintain the layer's structural integrity upon film formation) but are advantageously used as coatings on a substrate such as paper or paper board, or other paper-based material. Free-standing films can be cast on support substrate bodies or molds or in other manners. The free-standing film can also be applied to a substrate through various techniques such as lamination and others known to one skilled in the art.

Paper-based materials used as substrates to which treatment compositions can be applied include materials typically comprising an amalgam of cellulose fibers, from natural and/or man-made sources. Other types of fillers and additives can be used in manufacturing a paper-based material, either from natural or man-made sources. The treatment composition may itself also contain fillers such as calcium carbonate, clay, or the like. In embodiments, the treatment composition may be formulated to act as a water barrier, a gas barrier, and/or to enhance certain physical properties of the substrate to which it is applied. For example, a properly-formulated treatment composition can improve the handling properties of the substrate or its receptivity to printing inks or to adhesives, as would be apparent to those of ordinary skill in the art.

In other embodiments, a treatment composition can be formulated to avoid the use of particular materials, which may be of concern to consumers and/or manufacturers. Accordingly, some of the embodiments disclosed herein can be substantially free of typical wax paper coatings (e.g., paraffin), polyolefins and/or polyfluorinated materials (e.g., a dried treatment layer can contain less than about 5%, 2%, 1%, 0.1%, or 0.01% by weight of a polyolefin, a polyfluorinated material, or both).

In some embodiments, a treatment layer comprises a grease-resistant film, coating or other structure including an acrylic-based polymer material and a complementary material. In some instances, the treatment layer can be formulated with components (e.g., the acrylic polymer and the complementary material) to form a mixture, which can be an amorphous substantially uniform material (e.g., the acrylic polymer and the complementary component(s) can both be compatible with an aqueous-based material). As well, the treatment layer can be adapted to be more grease resistant than the substrate (e.g., paper-based material) to which it is applied.

In many instances, the presence of a complementary material can act to soften an acrylic-based polymer layer, which can make a treatment layer more robust and less susceptible to rupturing. While some acrylic-based polymers are capable of providing grease resistance, in many instances such polymer layers are brittle and susceptible to rupture when applied to a paper-based material and the layered material is creased. Accordingly, when a treatment layer includes an appropriate complementary material and acrylic-based polymer, the resulting treatment layer can be less brittle than a similarly dimensioned layer that consists of the acrylic-based polymer. For example, a dried treatment layer can exhibit a lower glass transition temperature (herein “T_{g}”) relative to the T_{g} of an acrylic-based polymer used in the treatment layer. In some instances, the treatment layer on a paper-based material can be formulated to allow the ensemble to be creased (e.g., folded with a selected pressure such as a pressure less than about 50, 40, 30, 20, or 10 psi) while still having improved grease resistance vis-à-vis the untreated paper-based material.

As well, some embodiments of treatment compositions comprising acrylic-based polymers can lead to easier formation of and/or better performing grease-resistant films, layers, etc. As documented in the examples herein, treatment formulations can be formulated with high solid weight fractions (e.g., about 20% to about 50% or higher), while still maintaining a low enough formulation viscosity for processing. Accordingly, such formulations can lead to easier formed, and better performing, grease resistant compositions. Some known grease-resistant treatment formulations (e.g., formulations that may utilize a cellulose-based material) may result in higher viscosities at lower solids fractions, making their usage somewhat more laborious.

The acrylic-based polymer material can be any acrylic-based resin system that when polymerized, becomes insoluble in grease or oil. In general, acrylic-based polymers can include polymers and/or copolymers that can include acrylate monomers like acrylic acid and/or substituted acrylic acids and/or esters of acrylic acid and substituted acrylic acids.

In some embodiments, an acrylic based polymer contains a plurality of units represented by Structural Formula (I):

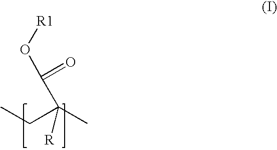

where R and R1 are each, independently, any one of hydrogen, or a substituted or unsubstituted C1 to C6 hydrocarbyl group. Substitutions for a carbon atom can include a heteroatom such as sulfur, oxygen, or nitrogen, which can form units of acrylonitrile, for instance.

In particular embodiments, R1 is not hydrogen; omission of acrylic acid related units can potentially help decrease an undesired hygroscopic effect in some instances. In other particular embodiments, R1 is an unsubstituted, saturated C1-C6 hydrocarbyl group; or an unsubstituted, saturated C1-C4 hydrocarbyl group; or an unsubstituted, saturated C1-C3 hydrocarbyl group; or an ethyl or methyl group; or a methyl group.

In some embodiments, R is an unsubstituted, saturated C1-C6 hydrocarbyl group; or an unsubstituted, saturated C1-C4 hydrocarbyl group; or an unsubstituted, saturated C1-C3 hydrocarbyl group; or an ethyl or methyl group; or a methyl group. In other embodiments, the potential possibilities for R named above can also include hydrogen. In yet other possibilities, R is hydrogen.

Other embodiments can include any potential combination of R and R1 as described above. For instance, R can be hydrogen, methyl or ethyl; and R1 can be non-hydrogen or methyl or ethyl.

In some embodiments, an acrylic-based polymer is a waterborne polymer, which can increase a composition's compatibility in many papermaking processes. An example of such an acrylic is Michelman's Micryl 766R, which includes polymers having polymethyl methacrylate units. An acrylic-based polymer material useful in the practice of systems and methods as described herein can be applied either as a reactive precursor (e.g., a monomer system, prepolymer system, etc.) or a fully formed polymer. In some embodiments, the acrylic polymer material can be applied as a reactive precursor, for example in a treatment composition, to limit viscosity at high solids content. In another embodiment, the acrylic material and/or the complementary material may have functional groups that could be activated using irradiation such as UV light to effect, for example, chemical reactions and/or polymerization.

As utilized within the present application, the term “polymer” refers to a molecule comprising repeat units, wherein the number of repeat units in the molecule is greater than about 10 or about 20. A molecule having fewer than about 20 repeat units can be termed an “oligomer.” Oligomers can also be defined as having at least 5 repeat units (e.g., adjacently connected). Repeat units can be adjacently connected, as in a homopolymer. The units, however, can be assembled in other manners as well. For example, a plurality of different repeat units can be assembled as a copolymer. If A represents one repeat unit and B represents another repeat unit, copolymers can be represented as blocks of joined units (e.g., A-A-A-A-A-A . . . B-B-B-B-B-B . . . ) or interstitially spaced units (e.g., A-B-A-B-A-B . . . or A-A-B-A-A-B-A-A-B . . . ), or randomly arranged units. In general, polymers include homopolymers, copolymers (e.g., block, inter-repeating, or random), cross-linked polymers, linear, branched, and/or gel networks, as well as polymer solutions and melts. Polymers can also be characterized as having a range of molecular weights from monodisperse to highly polydisperse. In some embodiments of the invention, a grease-resistant composition can comprise at least a portion of a polymer comprising an acrylic resin, and/or having a plurality of units consistent with Structural Formula (I). As well, acrylic-based polymers can include variations of different units, in block or random or sequential order, where at least some, or all, of the different units are consistent with Structural Formula (I).

Complementary components can include any material that can combine with an acrylic-based polymer to form a treatment layer consistent with some embodiments of the present invention. In some embodiments, the complementary component can have a weight ratio relative to the acrylic-based polymer that is sufficient to achieve one or more of the desired functionalities of a treatment layer. Accordingly, the weight ratio of complementary component to acrylic-based polymer in a treatment layer or composition can be greater than any one of 3:100, 4:100, 5:100, 10:100, or 20:100. In some embodiments, the weight ratio of the complementary component to the acrylic-based polymer can be no higher than a designated ratio. Such a ratio can be such as to insure that a treatment composition exhibits a desired level of grease-resistance as imparted by the acrylic-based polymer. Accordingly the weight ration of complementary component to acrylic-based polymer can be lower than about 1:2, 1:3, 1:4, or 1:5.

Complementary components useful for forming a treatment composition can include any material that is dispersible and/or soluble with the acrylic-based polymer, and can optionally act to provide a treatment layer exhibiting a lower T_{g} than the acrylic-based polymer itself under similar conditions. The term “dispersible” implies that the components can be mixed together, though the components need not be completely miscible with one another (e.g., the components can form an emulsion, such as a microemulsion, or be a dispersions of two domains intermingled together to some extent). In general, when a mixture contains an acrylic-based polymer and complementary component(s) that are dispersible (e.g., in an aqueous medium), such a mixture will not tend to form macroscopically-settled phases during mixture storage. In one example, the complementary component can be soluble or otherwise dispersible in water and/or the acrylic waterborne system. The complementary component can be a small molecule, oligomer, or polymer. In some instances, the complementary component is a polymer or a small molecule. In other instances, the complementary component is a polymer or an oligomer, or only a polymer. A complementary component that is a polymer or an oligomer can form a treatment layer that can hinder the component's ability to leach out of the treatment layer after formation on a substrate.

In some embodiments, a complementary component can make a resulting film more pliable (e.g., softer) by making it less likely to crack or fail upon creasing, folding, or otherwise deforming the treatment layer as discussed earlier. In particular, such complementary components, which can be a polymer or oligomer, can provide improved fatigue characteristics for a treatment layer relative to the use of particular small molecule plasticizers. Any polymer or oligomer that is compatible with an acrylic-based polymer can be utilized, although it can be advantageous to have the complementary component act to soften the resulting treatment composition. In embodiments, the complementary component can have a low T_{g} (e.g., less than 100° C.). The complementary component molecular weight can range from 100 up to 10,000,000 Daltons. In embodiments, the complementary component has a molecular weight between 200 to 10,000 Daltons. In other embodiments, a complementary polymer excludes the use of surfactant-like polymers and oligomers such as alkylpolyglycocides, which can have a tendency to segregate in a treatment composition, leading to a non-desirable heterogeneous grease-resistant layer.

Some suitable complementary components can include water-borne polymers that are dispersible with an acrylic-based polymers (e.g., polymers/oligomers having one or more alcohol groups). Non-limiting instances of complementary components include polymers (e.g., homopolymers or copolymers) and/or oligomers such as polyols and polyoxazoline. Polyols include polymers including an ether repeat unit such as polyglycols. For example, acrylic-based polymer can be mixed advantageously with a complementary material like polyethylene glycol (PEG) or polypropylene glycol (PPG) or a copolymer with units of any one of PEG and PPG for softening purposes in accordance with the systems and methods disclosed herein. Systems including at least one of a polyol and a polyoxazoline polymer/oligomer have been found unexpectedly to make a treatment layer having an acrylic-based polymer more compliant without disrupting its integrity. Oligomers having repeat units similar to polyols and polyoxazoline can also be utilized. In some instances, the oligomer/polymer has enough units to substantially distinguish the complementary component from a single monomer molecule (e.g., a glycol), which can act purely as a solvent.

In some embodiments, the complementary component can have one or more functional groups, such as epoxies or acrylates, which can react with the acrylic-based polymer. Such reaction can result in at least partial binding between the complementary component and an acrylic-based polymer (e.g., one or more covalent bonds). Such reactions can also reduce the complementary material's ability to migrate out of the coating or film. PEG, PPG, and polyoxazoline are some examples of such complementary components. In some embodiments, a reactive oligomer like polyethylene glycol diglycidyl ether, polypropylene glycol diglycidyl ether and the like can be used as a reactive precursor to forming a complementary component. As used herein, the term “reactive oligomer” refers to an oligomer that has functional groups that react with an acrylic resin polymer system as described herein. Reactive oligomers and/or precursors can be components of a treatment composition that can be reacted to form a treatment layer contacting a substrate.

In some embodiments, it can be desirable to utilize a complementary component that has a low tendency to leach out of a treatment layer, such as a polymer. For instance, in food applications, it is especially desirable to use a complementary component that does not substantially leach out of the composition. In some embodiments treatment compositions employing acrylic-based polymers and complementary components, or their precursors, can avoid the addition of substantial amounts of particular types of plasticizers that are prone to leaching out of a treatment composition after a substrate has been treated. These embodiments can be especially preferred in food applications because their components will not leach into the food product, which can require further downstream processing.

In some embodiments, a grease-resistant composition can include an acrylic-based polymer combined with a compatible complementary polymer or oligomer that can enhance the overall mechanical performance of the mixture, especially the fatigue resistance. Therefore the resulting grease-resistant composition is resilient and resists cracking or crazing. In some embodiments, the components of the composition are sufficiently compatible so that large heterogeneous phases do not emerge; such highly phase-separated morphology can detrimentally affect the overall mechanical performance of the composition, promoting film cracking and crazing. As well, using certain complementary materials can enhance the fatigue-resistance of the treatment composition. It is preferable that the system does not degrade, melt, or undergo a glass transition at high temperatures, so that the system is stable at temperatures of at least up to 100° F., 100° C., and preferably at least up to 175° C.

Films and coatings embodying the disclosed treatment layers can be directly coated onto the substrate using such techniques as solvent-casting, spray or dip coating, or extrusion. The films and/or coatings also may provide resistance to other liquids and vapors such as water. The term “treatment composition” can be used to refer to the material that is actually applied to the substrate. The treatment composition can be the treatment layer itself or a precursor form of the treatment layer such as the grease-resistant composition diluted in a solvent and/or other components that are eliminated from the initially-applied treatment composition as it sets on a substrate. In other embodiments, treatment compositions can be utilized simultaneously with the manufacturing of the substrate. In such instances, grease-resistant properties can be embedded with the substrate directly. For example, during the various phases of a paper-making process, a treatment composition consistent with various embodiments disclosed herein, can be added in with the actual components that are used to form a sheet or paperboard.

In some embodiments, treatment compositions can be dissolved, suspended, or otherwise dispersed in a solvent, or can be dispersed (e.g., melted) and applied without a solvent (e.g., a polymer melt that optionally includes one or more other components). The solvent for a treatment composition can be any solvent or solvent combination that dissolves or otherwise disperses the polymers and/or other components of the treatment composition. Accordingly, in some embodiments the acrylic-based polymer and complementary component of a treatment composition can be soluble or miscible with one another. In some cases, water-based systems may be preferred, but in others, it may be desirable to add quicker drying solvents such as alcohols. Accordingly, some treatment compositions can be formulated as a single-phase system (e.g., aqueous phase system) or a meta-stable system, i.e., a system that does not undergo substantial phase separation on the time-scale of formulation preparation and/or coating on the substrate. In such instances, embodiments that utilize an acrylic based polymer and a complementary component (e.g., polymer) can involve a degree of compatibility between the different types of polymers consistent with a single phase system or a meta-stable system.

In some embodiments, the treatment composition can be an emulsion. In embodiments formulated as an emulsion, the acrylic-based polymer can be emulsified with a secondary polymer. An emulsifying aid such as a surfactant can be added as well to help stabilize the emulsion. Emulsions can be applied using any known coating technique as part of the paper making process (such as in a size press) or as a post treatment on a coating machine. It can be sprayed onto the sheet, extruded onto the sheet, or transferred using a roll to name a few coating technique examples. The treatment composition can be applied to any substrate but it is specifically designed for paper or paperboard. For instance, an acrylic-based polymer (e.g., Micryl 766R) can be processed as a latex treatment composition for application to a paper-based material.

In some embodiments, the acrylic-based polymer and complementary component can be combined with other additives, for example, a small-molecule plasticizer and/or a filler. Combinations of an acrylic resin polymer, a complementary polymer, and a plasticizer can be formed that have the desirable properties of oil resistance, fatigue resistance and high temperature stability. In embodiments in which a small molecule plasticizer is present, a variety of agents can be utilized so long as the agent is compatible with the acrylic-based polymer and other components in the treatment composition. Non-limiting examples of small molecule plasticizers include triacetin, glycol phthalate, diethyl phthalate, tributyl phosphate or dibutyl phthalate. An amount of added plasticizer can be sufficiently high that it softens the acrylic-based polymer material or the treatment composition containing it, but sufficiently low that it retains the oil resistance property. For example, the plasticizer can be in the range of 5-40%. The amount of plasticizer that is suitable depends also on the temperature of the application. For example, high temperature applications use less plasticizer (e.g., a range of about 5-20%).

Other additives can be added to the treatment compositions consistent with embodiments herein. Preferably, such additives do not adversely affect the properties of the treatment composition. For example, inorganic fillers, antioxidants, food dyes and the like may be added. Inorganic fillers can act to lower the cost of the treatment composition, while maintaining the desired properties of the treatment layer. In some embodiments, the weight fraction of inorganic fillers in a treatment layer can be less than about 67% by volume, or less than about 50% by volume, or less than about 40% by volume. Other examples may be readily apparent to those of ordinary skill in the art. Any compatible types of inorganic fillers can be utilized (e.g., calcium carbonate (e.g., precipitated), kaolin, silica-based, dolomite, calcium sulphate, talc, titanium oxide, aluminum hydroxide, etc.), in various embodiments. However, in some instances, the inorganic filler can substantially lack a material that exhibits a crystalline platelet structure (e.g., the inorganic filler is less than about 5%, 1%, 0.1%, or less than about 0.01% by weight of a material having a crystalline platelet structure). While materials having a crystalline platelet structure have been used to enhance moisture migration, some embodiments of the present invention advantageous provide grease resistant properties without the need to resort to such geometric effects. In other embodiments, the treatment layer can be substantially free of inorganic fillers.

In some embodiments, the polymers in the treatment composition can be crosslinked. This crosslinking can be performed by including molecules, i.e., crosslinkers, that crosslink the acrylic resin polymers together. The acrylic system can also crosslink itself, for example with a multifunctional acrylic. Crosslinkers can also crosslink a complementary polymer to itself or to the acrylic resin polymer. Examples of crosslinking agents include melamine-formaldehyde resins, urea-formaldehyde resins, and epoxidized polyamine-polyamide resins. Multifunctional epoxies can also be used as a crosslinker. The crosslinker can be either added into the treatment composition, or applied in a second coating step. Crosslinking may be advantageous so that the treatment composition can be delivered in a solvent such as water but then not be dissolvable in the solvent after crosslinking.

### EXAMPLES

The following examples are provided to illustrate some aspects of the present application. The examples, however, are not meant to limit the practice of any embodiment of the invention.

### Materials

In the examples below, the following materials were used:
Acrylic resin —Michelman (Cincinnati, Ohio) Micryl 766R
Castor Oil—Mallinckrodt Baker, Inc. (Phillipsburg, Pa.) 1518-01
Heptane—VWR (West Chester, Pa.) 142-82-5
Toluene—Aldrich (St. Louis, Mo.) 179418
Palm Oil (no specific source)
Poly(ethylene glycol) 400 Mₙ—Fluka (Belgium) 81170
Poly(ethylene glycol) 1,000 Mₙ—Sigma Aldrich (St. Louis, Mo.) P3515
Poly(ethylene glycol) 200,000 Mₙ—Sigma Aldrich (St. Louis, Mo.) 181994
Poly(ethylene glycol)(200 molecular weight), diglycidyl ether terminated—Polysciences, Inc. (Warrington, Pa.) 08209
Poly(ethylene glycol) (1000 molecular weight), diglycidyl ether terminated—Polysciences, Inc. (Warrington, Pa.) 24047
Poly(2-ethyl-2-oxazoline) 5,000 Mn—Polysciences, Inc. (Warrington, Pa.) 24066
Poly(ethylene glycol), diacrylate—Sigma Aldrich (St. Louis, Mo.) 437-441
Poly(propylene glycol), diglycidyl ether—Sigma Aldrich (St. Louis, Mo.) 406740
Precipitated calcium carbonate (PCC)—Specialty Minerals (New York, N.Y.) VicalityAlbaglos 100-0540-3
Kaolin—Dow Chemical Co. (Midland, Mich.)
Poly(propylene glycol), diglycidyl ether —Dow Chemical Co. (Midland, Mich.) PPGDGE Dow DER 732
Poly(propylene glycol)—Dow Chemical Co. (Midland, Mich.) PPG Dow P-425

### Sample Preparation and Testing Procedures

A. Coating Preparation

In Examples 1-11 below, the coating was prepared as follows: a draw down was performed with the test solution using a 6″ bar with a 5 mil gap. A single coat of the test solution was applied (unless otherwise specified) on a basis sheet and left to air dry. In the examples below, the following test procedures were used:

B. ANSI Test

ANSI test method T 559, which expands upon TAPPI UM 557 “Repellency of Paper and Board to Grease, Oil, and Waxes (Kit Test),” was employed in certain examples. The test involved releasing a drop of a mixture of castor oil, heptane, and toluene (twelve different mixtures are made and numbered 1-12 based on the aggressiveness of the mixture, with 12 being the most aggressive solvent mixture) onto the coating for 15 seconds and determining if the sheet darkened in color. Failure was indicated by the darkening or discoloring of the test paper. The paper is given the score of the highest number of solution that can be applied without failure, using a ranking from 1-12 (the “Kit Score”).

C. Boat Test

Boat tests were performed by creating a boat-shaped construct with the coated sheet so that it can hold oil. Briefly, a 5″ by 6″ piece of coated paper was creased in the middle by applying 20 psi of pressure, and then the edges were folded up to create a boat-like structure. Palm oil was placed in the boat and the boat was place in an oven on a piece of paper for 24 hrs at 37° C. The paper underneath the boat was observed for grease spots after the given time and the number and diameter of the spots were recorded.

D. Fatty Acid Test

The fatty acid test, developed by Solvay Chemicals, utilizes natural fatty acids to determine the grease resistance of paper. A set of test solutions is prepared with various amounts of castor oil, oleic acid, and octanoic acid. Each member of the test solution set is ranked from 1 to 11, with 1 being the least aggressive solution (i.e., having a lower percentage of a smaller molecular weight fatty acid (here octanoic acid) with higher penetration power than the higher molecular weight fatty acids (here, castor oil or oleic acid)) and 11 being the most aggressive. The solutions are heated to 60° C. and a drop of each is placed on the test paper and the paper is placed in a 60° C. oven for 5 minutes. After five minutes the drop is wiped off and the paper is examined: Failure is indicated by the darkening or discoloring of the test paper. The paper is given the score of the highest number of solution that can be applied without failure (i.e., darkening or discoloration after five minutes).

E. Flexographic Printing Technique for Grease Resistant Formulation Application

Print runs were performed on a 10″ wide, 3-Color Combo Commander Flexo Printing Press. The machine speed was set at 50 ft/min using Boise coating base stock and Boise waxing base stock. The waxing base stock was a preferred stock to use because it contains wet strength additives and would not break during production runs in which it is coated with an aqueous solution. The waxing base stock was used for the majority of the print runs. The coating formulations were used in one, two or three printing stations at concentrations of either 35% solids or 50% solids to achieve a wide range of coat weights that were used in the Examples below. Each station was equipped with an anilox roll, which was fed via a feed roll in contact with a trough having a given coating composition. Each station had its own drying equipment. Control of a coating process was therefore effected by using individual printing stations with and without drying inbetween coating steps. Anilox rolls of 100, 140, 200, and 360 lines per inch (herein “lpi”) were used for printing.

### Example 1

### Acrylic Resin

A 23.3% solids solution was prepared by diluting 4 mLMicryl 766R (35% solids w/v) with 2 mL water. The ANSI score of the coat was 12 without a crease and 6 with a crease. The boat test was not performed.

### Example 2

### Acrylic Resin with Triacetin

A 31.7% solids solution was prepared by dissolving 0.5 g triacetin in 4 mL of Micryl 766R and diluting the mixture with 2 mL water. The ANSI score of the coat was 11 without a crease and 8 with a crease. The boat test was not performed.

### Example 3

### Acrylic Resin with Poly(ethylene Glycol)(200 Molecular Weight)

A 31.7% solids solution was prepared by dissolving 0.5 g poly(ethylene glycol)(200 molecular weight), diglycidyl ether terminated, in 4 mL of Micryl 766R and diluting the mixture with 2 mL water. The ANSI score of the coat was 12 without a crease and 12 with a crease. The boat test resulted in no grease spots.

### Example 4

### Acrylic Resin with Poly(ethylene Glycol)(1000 Molecular Weight)

A 31.7% solids solution was prepared by dissolving 0.5 g poly(ethylene glycol)(1000 molecular weight), diglycidyl ether terminated, in 4 mL of Micryl 766R and diluting the mixture with 2 mL water. The ANSI score of the coat was 12 without a crease and 12 with a crease. The boat test was not performed.

### Example 5

### Acrylic Resin with Poly(ethylene Glycol) 400 Mₙ

A 31.7% solids solution was prepared by dissolving 0.5 g poly(ethylene glycol), 400 Mₙ, in 4 mL of Micryl 766R and diluting the mixture with 2 mL water. The ANSI score of the coat was 12 without a crease and 12 with a crease. The boat test resulted in an average of 17 grease spots ranging from 0.2-1.4 cm in diameter.

### Example 6

### Acrylic Resin with Poly(ethylene Glycol) 1000 Mₙ

A 31.7% solids solution was prepared by dissolving 0.5 g poly(ethylene glycol), 1,000 Mₙ, in 4 mL of Micryl 766R and diluting the mixture with 2 mL water. The ANSI score of the coat was 11 without a crease and 9 with a crease. The boat test was not performed.

### Example 7

### Acrylic Resin with Poly(ethylene Glycol) 200,000 Mₙ

A 31.7% solids solution was prepared by dissolving 0.5 g poly(ethylene glycol), 200,000 Mₙ, in 4 mL of Micryl 766R and diluting the mixture with 2 mL water. The ANSI score of the coat was 8 without a crease and was not performed with a crease. The boat test was not performed.

### Example 8

### Acrylic Resin with Poly(2-ethyl-2-oxazoline)

A 31.7% solids solution was prepared by dissolving 0.5 g poly(2-ethyl-2-oxazoline), 5,000 Mₙ, in 4 mL of Micryl 766R and diluting the mixture with 2 mL water. The ANSI score of the coat was 7 without a crease and was not performed with a crease. The boat test was not performed.

### Example 9

### Acrylic Resin with Poly(ethylene Glycol) Diacrylate

A 31.7% solids solution was prepared by dissolving 0.5 g poly(ethylene glycol) diacrylate, in 4 mL of Micryl 766R and diluting the mixture with 2 mL water. The ANSI score of the coat was 12 without a crease and 12 with a crease. The boat test resulted in an average of 20 grease spots ranging in diameter from 0.3-1.8 cm.

### Example 10

### Acrylic Resin with Poly(propylene Glycol)diglycidyl Ether Terminated

A 31.7% solids solution was prepared by dissolving 0.5 g poly(propylene glycol), diglycidyl ether terminated, in 4 mL of Micryl 766R and diluting the mixture with 2 mL water. The ANSI score of the coat was 12 without a crease and 12 with a crease. The boat test resulted in no grease spots.

### Example 11

### Acrylic Resin with 20% PCC

A 34.3% solids solution was prepared by dissolving 0.5 g poly(ethylene glycol)(200), digycidyl ether terminated and 0.5 g precipitated calcium carbonate in 4 mLMicryl 766R and diluting the mixture with 3 mL water. The ANSI score of the coat was 12 without a crease and 12 with a crease. The boat test resulted in no grease spots.

### Example 12

### Application of Grease Resistant Coating Using a Single Coating Station on the Flexographic Printer Using 58.4% Micryl 766/20.8% PPG Dow P-425/20.8% Kaolin

Using the flexographic printing technique, a grease-resistant coating using 58.4% Micryl 766/20.8% PPG Dow P-425/20.8% kaolin was applied to a waxing base stock at the coat weights set forth in Table 1. The coating was applied at 50% solids. The coated papers were tested according to the ANSI, fatty acid, and boat tests described herein. The results of these tests are set forth in Table 1. The Kit Test Scores show that good oil and grease repellency is obtained at higher coat weights. Test results for the boat test, based on the number of oil spots that are seen on the paper placed beneath the boat, include the number of spots that were counted and the range in size of these spots. For example, a score of 19/0.1-1.3 indicates that there were 19 spots with ranges in size from 0.1 cm to 1.3 cm.

TABLE 1

| | | Coat Weight | Kit | | |
|---|---|---|---|---|---|
| Anilox LPI | Solids % | (lb/ream) | Score | Fatty Acid | Boat Test |
| 100 | 50 | 3.39 | 10 | 4 | 19/0.1-1.3 |
| 140 | 50 | 1.70 | 7 | 3 | 16/0.3-2.4 |
| 200 | 50 | 1.48 | 5 | 0 | Failed |
| 200 | 50 | 0.52 | 0 | 0 | Failed |
| 360 | 50 | 0.89 | 0 | 0 | Failed |
| 100 | 50 | 4.58 | 11 | 2 | Failed |
| 140 | 50 | 2.90 | 7 | 2 | Failed |
| 200 | 50 | 1.59 | 5 | 0 | Failed |
| 200 | 50 | 2.09 | 2 | 0 | Failed |
| 360 | 50 | 1.10 | 1 | 0 | Failed |

### Example 13

### Application of Grease Resistant Coating Using Dual Coating Stations on the Flexographic Printer Using 58.4% Micryl 766/20.8% PPG Dow P-425/20.8% Kaolin

To improve further the oil and grease resistance, and the boat test results, a different coating approach was used by varying the number of coating stations. Using the flexographic printing technique, a grease-resistant coating using 58.4% Micryl 766/20.8% PPG Dow P-425/20.8% kaolin was applied to a waxing base stock in two adjacent printing stations using Anilox rolls as set forth in Table 2. The coating was applied at 50% solids. The coated papers were tested according to the ANSI, fatty acid, and boat tests described herein. The results of these tests are set forth in Table 2. The Kit Test Scores show that good oil and grease repellency is obtained at higher coat weights along with good fatty acid scores. The samples coated using the double coating stations passed the boat test without any leaks at coat weights higher than approximately 3 lb.

TABLE 2

| Anilox 1 | Solids 1 | Anilox 2 | Solids 2 | Coat Weight | Kit | Fatty | Boat |
|---|---|---|---|---|---|---|---|
| LPI | % | LPI | % | (lb/ream) | Score | Acid | Test |
| 100 | 50 | 200 | 50 | 5.31 | 12 | 11 | Pass |
| 140 | 50 | 200 | 50 | 3.88 | 12 | 11 | Pass |
| 200 | 50 | 200 | 50 | 2.99 | 12 | 11 | 1/0.9 |
| 100 | 50 | 360 | 50 | 4.27 | 12 | 5 | 3/0.1-0.3 |
| 140 | 50 | 360 | 50 | 3.44 | 11 | 5 | 4/0.1-0.9 |
| 200 | 50 | 360 | 50 | 2.33 | 10 | 3 | 7/0.3-1.5 |
| 200 | 50 | 200 | 50 | 2.35 | 7 | 1 | Fail |
| 360 | 50 | 360 | 50 | 1.01 | 2 | 0 | Fail |

### Example 14

### Application of Grease Resistant Coating Using a Double Coating Station on the Flexographic Printer (Double Bump) Using 58.4% Micryl 766/20.8% PPG Dow P-425/20.8% Kaolin at 50% and 35% Solids

To improve further the oil and grease resistance at lower coat weights, a different coating approach was used by varying the number of coating stations and the % solids in the coating solutions. Using the flexographic technique described in Example 13, a grease resistant coating was applied to a waxing base stock using two coating stations with the coating formulation at 35% and 50% solids. The anilox roll selection was made to minimize the thickness of the coating. The coated papers were tested according to the ANSI, fatty acid, and boat tests described herein. The results of these tests are set forth in Table 3. The results show the lower coat weights obtained, and the corresponding kit scores. A significant improvement in kit scores is seen at lower coat weights compared to previous examples.

TABLE 3

| | | | | Coat | | |
|---|---|---|---|---|---|---|
| Anilox 1 | Solids 1 | Anilox 2 | Solids 2 | Weight | Kit | Boat |
| LPI | % | LPI | % | (lb/ream) | Score | Test |
| 200 | 35 | 200 | 50 | 0.91 | 6 | |
| 360 | 35 | 200 | 50 | 1.30 | 5 | Not |
| | | | | | | performed |
| 200 | 50 | 200 | 35 | 1.27 | 7 | Not |
| | | | | | | performed |
| 200 | 50 | 360 | 35 | 0.94 | 7 | Not |
| | | | | | | performed |
| 200 | 35 | 360 | 35 | 0.35 | 1 | Not |
| | | | | | | performed |
| 360 | 35 | 200 | 35 | 0.69 | 1 | Not |
| | | | | | | performed |
| 200 | 35 | 200 | 50 | 1.03 | 1 | Not |
| | | | | | | performed |
| 360 | 35 | 200 | 50 | 0.98 | 1 | Not |
| | | | | | | performed |
| 200 | 50 | 200 | 35 | 0.99 | 7.67 | Not |
| | | | | | | performed |
| 200 | 50 | 360 | 35 | 1.28 | 7 | Not |
| | | | | | | performed |
| 200 | 35 | 360 | 35 | 0.14 | 0.67 | Not |
| | | | | | | performed |
| 360 | 35 | 200 | 35 | 0.18 | 1 | Not |
| | | | | | | performed |
| 200 | 35 | 200 | 50 | 1.29 | 6 | Fail |
| 360 | 35 | 200 | 50 | 0.93 | 6 | Fail |
| 200 | 50 | 200 | 35 | 1.48 | 6 | Fail |
| 200 | 50 | 360 | 35 | 1.35 | 6 | Fail |
| 200 | 35 | 360 | 35 | 1.36 | 5 | Fail |
| 360 | 35 | 200 | 35 | 0.87 | 5 | Fail |

### Example 15

### Application of Grease Resistant Coating Using a Triple Coating Station on the Flexographic Printer Using 58.4% Micryl 766/20.8% PPG Dow P-425/20.8% Kaolin at 50% and 35% Solids

To improve further the oil and grease resistance at lower coat weights, a different coating approach was used by varying the number of coating stations and the % solids in the coating solutions. Using the flexographic technique described in Example 13, a grease resistant coating was applied to a waxing base stock using three coating stations with the coating formulation at 35% and 50% solids. The anilox roll selection was made to minimize the thickness of the coating. The coated papers were tested according to the ANSI, fatty acid, and boat tests described herein. The results of these tests are set forth in Table 4. The results show the lower coat weights obtained and the corresponding kit scores.

TABLE 4

| Anilox 1 | Solids 1 | Anilox 2 | Solids 2 | Anilox 3 | Solids 3 | Coat Weight | Kit | Boat |
|---|---|---|---|---|---|---|---|---|
| LPI | % | LPI | % | LPI | % | (lb/ream) | Score | Test |
| 200 | 50 | 200 | 50 | 360 | 35 | 2.41 | 12 | 5/0.1-0.5 cm |
| 200 | 50 | 200 | 35 | 360 | 35 | 2.02 | 12 | 8/0.1-1.3 cm |
| 200 | 35 | 200 | 35 | 360 | 35 | 1.41 | 10 | Fail |
| 200 | 35 | 200 | 50 | 360 | 35 | 1.53 | 12 | 6/0.1-1.1 cm |

### Example 16

### Application of a Reactive Grease Resistant Coating Formulation Using a Single Coating Station on the Flexographic Printer (Single Bump) Using 58.4% Micryl 766/20.8% PPGDGE Dow DER 732/20.8% Kaolin

Using the flexographic printing technique, a reactive grease-resistant coating using 58.4% Micryl 766/20.8% PPGDGE Dow DER 732/20.8% kaolin was applied to waxing base stock at the coat weights set forth in Table 5. The coating was applied at 50% solids. The coated papers were tested according to the ANSI, fatty acid, and boat tests described herein. The results of these tests are set forth in Table 5. The Kit Test Scores show that good oil and grease repellency is obtained at higher coat weights.

TABLE 5

| | | Coat Weight | Kit | | |
|---|---|---|---|---|---|
| Anilox LPI | Solids % | (lb/ream) | Score | Fatty Acid | Boat Test |
| 100 | 50 | 3.86 | 9 | 3 | 16/0.1-1.7 |
| 140 | 50 | 2.31 | 7 | 2 | 12/0.2-2.6 |
| 200 | 50 | 0.94 | 6 | 0 | Failed |
| 200 | 50 | 2.09 | 1 | 0 | Failed |
| 360 | 50 | 0.57 | 0 | 0 | Failed |
| 100 | 50 | 4.44 | 12 | 8 | 18/0.1-1.9 |
| 140 | 50 | 2.78 | 10 | 3 | 21/0.1-1.1 |
| 200 | 50 | 2.39 | 8 | 1 | 12/0.3-3.3 |
| 200 | 50 | 1.96 | 1 | 0 | Failed |
| 360 | 50 | 0.83 | 1 | 0 | Failed |

### Example 17

### Application of a Reactive Grease Resistant Coating Formulation Using Dual Coating Stations on the Flexographic Printer Using 58.4% Micryl 766/20.8% PPGDGE Dow DER 732/20.8% Kaolin

Using the flexographic printing technique, a reactive grease-resistant coating using 58.4% Micryl 766/20.8% PPGDGE Dow DER 732/20.8% kaolin was applied to a waxing base stock at the coat weights set forth in Table 6 using dual coating stations. The coating was applied at 50% solids. The coated papers were tested according to the ANSI, fatty acid, and boat tests described herein. The results of these tests are set forth in Table 6. The Kit Test Scores show that good oil and grease repellency is obtained at higher coat weights.

TABLE 6

| Anilox 1 | Solids 1 | Anilox 2 | Solids 2 | Coat Weight | Kit | Fatty | Boat |
|---|---|---|---|---|---|---|---|
| LPI | % | LPI | % | (lb/ream) | Score | Acid | Test |
| 100 | 50 | 200 | 50 | 4.67 | 12 | 3 | 2/0.1-0.3 |
| 140 | 50 | 200 | 50 | 3.63 | 12 | 3 | 5/0.1-0.4 |
| 200 | 50 | 200 | 50 | 2.97 | 12 | 2 | 9/0.1-0.9 |
| 100 | 50 | 360 | 50 | 3.60 | 12 | 3 | — |
| 140 | 50 | 360 | 50 | 2.77 | 11 | 3 | — |
| 200 | 50 | 360 | 50 | 1.95 | 8 | 0 | — |
| 200 | 50 | 200 | 50 | 1.51 | 5 | 0 | — |
| 360 | 50 | 360 | 50 | 0.08 | 0 | 0 | — |

### Example 18

### Application of Grease Resistant Coating Using a Single Coating Station on the Flexographic Printer (Single Bump) Using 58.4% Micryl 766/20.8% PPG Dow P-425/20.8% PCC

Using the flexographic printing technique, a grease-resistant coating using 58.4% Micryl 766/20.8% PPG Dow P-425/20.8% PCC was applied to a waxing base stock at the coat weights set forth in Table 7 using dual coating stations. The coating was applied at 35% solids. The coated papers were tested according to the ANSI, fatty acid, and boat tests described herein. The results of these tests are set forth in Table 7. The results demonstrate that use of Kaolin as filler (in Example 12) generally imparts better grease resistance than using PCC (in this Example).

TABLE 7

| | | Coat Weight | Kit | | |
|---|---|---|---|---|---|
| Anilox LPI | Solids % | (lb/ream) | Score | Fatty Acid | Boat Test |
| 100 | 35 | 1.84 | 6 | 0 | Failed |
| 140 | 35 | 1.20 | 4 | 0 | Failed |
| 200 | 35 | 1.52 | 4 | 0 | Failed |
| 200 | 35 | 1.02 | 0 | 0 | Failed |
| 360 | 35 | 1.02 | 0 | 0 | Failed |
| 100 | 35 | 1.01 | 4 | 0 | Failed |
| 140 | 35 | 0.76 | 3 | 0 | Failed |
| 200 | 35 | 0.66 | 3 | 0 | Failed |
| 200 | 35 | 0.06 | 0 | 0 | Failed |
| 360 | 35 | 0.28 | 0 | 0 | Failed |

### Example 19

### Application of a Reactive Grease Resistant Coating Using a Single Coating Station on the Flexographic Printer (Single Bump) Using 58.4% Micryl 766/20.8% PPGDGE Dow DER 732/20.8% PCC

Using the flexographic printing technique, a reactive grease-resistant coating using 58.4% Micryl 766/20.8% PPGDGE Dow DER 732/20.8% PCC was applied to a waxing base stock at the coat weights set forth in Table 8 using dual coating stations. The coating was applied at 50% solids. The coated papers were tested according to the ANSI, fatty acid, and boat tests described herein. The results of these tests are set forth in Table 8. The results demonstrate that the use of Kaolin as filler (Example 16) imparts better grease resistance than using PCC (in this Example).

TABLE 8

| | | Coat Weight | Kit | | |
|---|---|---|---|---|---|
| Anilox LPI | Solids % | (lb/ream) | Score | Fatty Acid | Boat Test |
| 100 | 50 | 4.91 | 9 | 6 | 32/0.2-1.2 |
| 140 | 50 | 2.74 | 6 | 3 | 20/0.3-1.6 |
| 200 | 50 | 2.11 | 6 | 0 | Failed |
| 200 | 50 | 2.38 | 2 | 0 | Failed |
| 360 | 50 | 1.36 | 1 | 0 | Failed |
| 100 | 50 | 3.69 | 10 | 3 | 14/0.2-1.5 |
| 140 | 50 | 2.24 | 8 | 1 | 14/0.3-2.7 |
| 200 | 50 | 1.68 | 6 | 0 | Failed |
| 200 | 50 | 1.09 | 3 | 0 | Failed |
| 360 | 50 | 1.40 | 1 | 0 | Failed |

### EQUIVALENTS

While specific embodiments of the subject invention have been discussed, the above specification is illustrative and not restrictive. Many variations of the invention will become apparent to those skilled in the art upon review of this specification. The features illustrated or described in connection with one embodiment may be combined with features of other embodiments. For example, aspects of the use of one complementary polymer in one embodiment can be substituted in other embodiments of grease-resistant compositions. Such modifications and variations are intended to be included within the scope of the present invention. Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification are approximations that may vary depending upon the desired properties sought to be obtained by the present invention. The words “a” and “an” are equivalent to the phrase “one or more.”

1. A grease-resistant paper product comprising:
a treated surface of a paper-based material, the treated surface including a dried treatment layer comprising an acrylic-based polymer and a complementary component, the complementary component being dispersible with the acrylic-based polymer, the treatment layer being more grease resistant that the paper-based material, and less brittle than an equally-dimensioned layer of the acrylic-based polymer.

2. The grease-resistant paper product of claim 1, wherein a weight ratio of complementary component to acrylic-based polymer in the treatment layer is greater than 3 to 100.

3. The grease-resistant paper product according to claim 1, wherein the treatment layer is a mixed composition.

4. The grease-resistant paper product according to claim 1, wherein the treatment layer exhibits a T_{g} lower than the T_{g} of the acrylic-based polymer.

5. The grease-resistant paper product according to claim 1, wherein the grease-resistant paper product is capable of being creased, the creased paper product still being more grease-resistant than the paper-based material.

6. The grease-resistant paper product according to claim 1, wherein the treatment layer is substantially free of inorganic filler.

7. The grease-resistant paper product according to claim 1, wherein the treatment layer further comprises an inorganic filler.

8. The grease-resistant paper product according to claim 1, wherein the treatment layer comprises an acrylic-based polymer crosslinked with a crosslinking agent.

9. The grease-resistant paper product according to claim 1, wherein the grease-resistant paper product is configured as a food packaging material.

10. The grease-resistant paper product according to claim 1, wherein the complementary component is incapable of substantial leaching out of the treatment layer.

11. The grease-resistant paper product according to claim 1, wherein the complementary component is a polymer.

12. The grease-resistant paper product of claim 11, wherein the complementary component includes at least one of a polyol and a polyoxazoline.

13. The grease-resistant paper product of claim 12, wherein the polyol is a polyglycol.

14. The grease-resistant paper product of claim 1, wherein the complementary polymer is at least partially bound to the acrylic-based polymer.

15. A method of producing a grease-resistant paper product, comprising:
providing a treatment composition comprising at least one of an acrylic-based polymer and a reactive precursor to the acrylic-based polymer, and at least one of a complementary component and a reactive precursor to the complementary component, the acrylic-based polymer and complementary component being dispersible with one another; and
forming a treatment layer from the treatment composition disposed on a surface of the paper product, the formed treatment layer being more grease-resistant than the paper product, and being less brittle than an equally dimensioned layer of the acrylic-based polymer.

16. The method of claim 15, wherein the step of forming comprises treating the surface of the paper with the treatment composition by at least one of solvent-casting, spraying, dip coating, and extrusion.

17. The method according to claim 15, wherein the step of forming comprises forming a free-standing film layer with the treatment composition; and applying the free-standing film layer to the surface of the paper product.

18. The method according to claim 15, wherein the treatment composition is a water-based composition.

19. The method according to claim 15, wherein the treatment composition is an emulsion.

20. The method according to claim 15, wherein the step of forming further comprises forming at least a portion of the paper product simultaneously using the treatment composition.

21. The method according to claim 15, wherein the complementary component is a polymer.

22. The method according to claim 15, wherein the reactive precursor to the complementary component is a reactive oligomer.

23. The method according to claim 15, wherein the complementary component includes at least one of a polyol and a polyoxazoline.

24. The method according to claim 15, wherein the treatment composition is formulated to hinder leaching of the complementary component from the formed treatment layer.

25. The method according to claim 15, further comprising:
reacting at least one of the acrylic-based polymer and the reactive precursor with at least one of a complementary component and a reactive precursor to the complementary component to cause binding.
